(19) United States
(12) Patent Application Publication
(10) Pub. No.: US 2019/0017867 A1
(43) Pub. Date: Jan. 17, 2019

(54) LIGHT EMITTING SENSING DEVICE AND MANUFACTURING METHOD THEREOF

(71) Applicant: Everlight Electronics Co., Ltd., New Taipei City (TW)

(72) Inventors: SHIH-WEN LAI, New Taipei City (TW); CHIH-HAO HSU, New Taipei City (TW); YI-HUI LIAO, New Taipei City (TW); JIAN-HONG LAI, New Taipei City (TW); YI-TING HUANG, New Taipei City (TW); KUAN-YU CHEN, New Taipei City (TW); SHU-WEI CHEN, New Taipei City (TW); CHIEH-YU KANG, New Taipei City (TW)

(73) Assignee: Everlight Electronics Co., Ltd., New Taipei City (TW)

(21) Appl. No.: 16/034,021

(22) Filed: Jul. 12, 2018

Related U.S. Application Data
(60) Provisional application No. 62/532,357, filed on Jul. 13, 2017.
(60) Provisional application No. 62/626,796, filed on Feb. 6, 2018.

(51) Int. Cl. G01J 1/42; G01J 1/04

(52) U.S. Cl. CPC G01J 1/4228; G01J 1/4204; G01J 1/0437; G01J 1/429

(57) ABSTRACT

The invention provides a light emitting sensing device and a manufacturing method thereof. The light emitting sensing device comprises: a non-translucent substrate having a first surface with at least one recess formed on the first surface; a light emitting element disposed in the at least one recess; a light sensing element disposed on the first surface; a first transparent material disposed in the at least one recess and covering the light emitting element; and a second transparent material disposed on the first surface and covering the light sensing element. The light emitting sensing device provided in this embodiment solves the problem in the prior art, the infrared light emitted by the light emitting chip irradiates into the sensing chip and causes the sensing chip to be interfered by the light of the light emitting chip resulting in reduced sensing accuracy.

### TECHNICAL FIELD

The present invention relates to a light emitting sensing field, and in particular, to a light emitting sensing device for sensing ambient light and distances and a manufacturing method thereof.

### BACKGROUND

The ambient light sensor is an optical component that can sense ambient light conditions, and adjust a display or a camera according to the light detected by the ambient light sensor. The distance sensor is configured to detect the distance of an object by using a “flyingtime” principle, and “flyingtime” is to calculate the distance to the object through measuring the time interval by emitting a particularly short light pulse and measuring the time from the emitting of the light pulse to reflection of the light pulse by the object. Common distance sensors include the optical distance sensor, the infrared distance sensor and the ultrasonic distance sensor, where most of the distance sensors used in mobile phones are infrared distance sensors, which have an infrared emitting tube and an infrared receiving tube. When the infrared lights emitted by the emitting tube are received by the receiving tube, indicating a relatively close distance, and the screen is required to be turned off to avoid unintended activation; when the receiving tube cannot receive the infrared lights emitted by the emitting tube, indicating a relatively long distance, and there is no need to turn off the screen. The two sensors aforementioned (i.e., the ambient light sensor and the distance sensor) are widely used in smartphones, where the ambient light sensor and the distance sensor are often packaged together to form a two-in-one ambient light and distance sensor while being used in mobile phones, and the ambient light and distance sensor will include the light emitting chip and the sensing chip.

At present, a method for packaging the light emitting chip and the sensing chip in the ambient light and distance sensor is as shown in FIG. 1A: first, die bonding, that is, the light emitting chip 30 and the sensing chip 20 are fixed on the substrate 10 at intervals; then wire welding, following with a first die pressing , that is, a transparent glue 40b is provided on the light emitting chip 30, and a transparent glue 40a is provided on the sensing chip 20, where the transparent glue 40b and the transparent glue 40a are the same transparent glue; next a first cutting, following with a second die pressing, that is, the packaging glue 50 is filled between the transparent glue 40b and the transparent glue 40a to reduce mutual interference between the light emitting chip 30 and the sensing chip 20; and then a second cutting is performed to obtain a single finished product. After final testing and packing, the entire packaging is completed. The ambient light and distance sensor obtained from the packaging is shown in FIG. 1B.

However, when the packaging structure of an ambient light and distance sensor is manufactured by the existing packaging method aforementioned, when the light emitting chip 30 is an infrared chip that can emit infrared lights, the infrared lights can penetrate the packaging glue 50 and the substrate 10 to interfere with the sensing chip 20, thereby reducing the sensing accuracy of the ambient light and distance sensor.

### SUMMARY

In view of the above problems, an object of the present invention is to provide a light emitting sensing device and a manufacturing method thereof, which avoid the problem of a reduced sensing accuracy of the sensing device caused by the light emitted by the light emitting element in the light emitting sensing device entering the sensing element.

To achieve the object aforementioned, the present invention provides a light emitting sensing device, and the light emitting sensing device includes:

a non-translucent substrate, having a first surface with at least one recess formed on the first surface;

a light emitting element, being disposed in the at least one recess;

a light sensing element, being disposed on the first surface;

a first transparent material, being disposed in the at least one recess and covering the light emitting element; and

a second transparent material, being disposed on the first surface and covering the light sensing element.

Preferably, a depth of the recess is 2 to 4 times of a height of the light emitting element.

Preferably, the non-translucent substrate includes a light absorbing material, the light reflectance of the non-translucent substrate is 0%-10%, and the light transmittance of the non-translucent substrate is 0%-5%.

Preferably, the light emitting element includes a light emitting diode for emitting infrared light.

Preferably, the light sensing element senses visible light and invisible light.

Preferably, the light sensing element includes a first light sensing unit, a second light sensing unit and a processing unit, where the first light sensing unit is configured to sense visible light and output a corresponding sensing signal to the processing unit, and the second light sensing unit is configured to sense invisible light emitting by the light emitting element and output a corresponding sensing signal to the processing unit.

Preferably, the first light sensing unit is an ambient light sensing unit, and the second light sensing unit is a distance sensing unit.

Preferably, the wavelength of the visible light sensed by the ambient light sensing unit is 400 nm-700 nm, and the wavelength of the invisible light emitted by the light emitting element and sensed by the distance sensing unit is 800 nm-1100 nm.

Preferably, the first transparent material and the second transparent material do not contact with each other.

Preferably, further including:

a color sensor and a third transparent material, where the color sensor is disposed on the first surface, and the third transparent material covers the color sensor.

Preferably, the color sensor has a sensing region, and the sensing region includes at least more than one of the following sensing regions:

red (R), green (G), blue (B), white (W), infrared (IR) and ultraviolet (UV) sensing regions; and

a light blocking structure is disposed between each two sensing regions.

Preferably, the color sensor includes an R sensing region, a G sensing region, a B sensing region, a W sensing region, and an IR sensing region, the R sensing region, the G sensing region, the B sensing region, the W sensing region, and the IR sensing region form a sensing matrix in a parallel and bisymmetric manner, the R sensing region, the G sensing region, the B sensing region, and the W sensing region are symmetrically distributed with respect to the IR sensing region in the sensing matrix, or,

one of the R sensing region, the G sensing region, the B sensing region, the W sensing region and the IR sensing region is positioned as a center of a circle, and the remaining four sensing regions are symmetrically and radially distributed around the center.

Preferably, the light blocking structure is made of metal or insulating material.

Preferably, an R transparent sheet is disposed on the R sensing region, and a waveband sensed by the R sensing region is 590 nm-750 nm.

a G transparent sheet is disposed on the G sensing region, and a waveband sensed by the G sensing region is 495 nm-590 nm;

a B transparent sheet is disposed on the B sensing region, and a waveband sensed by the B sensing region is 380 nm-495 nm;

an IR transparent sheet is disposed on the IR sensing region, and a waveband sensed by the IR sensing region is 750 nm-1100 nm;

a W transparent sheet is disposed on the W sensing region, and the waveband sensed by the W sensing region is 380 nm-750 nm.

Preferably, further including:

a multichip light emitting element and a third transparent material, where the multichip light emitting element is disposed on the first surface, and the third transparent material covers the multichip light emitting element; and

the multichip light emitting device includes at least one of the following light emitting chips:

Red (R) light emitting chip, green (G) light emitting chip, blue (B) light emitting chip and white (W) light emitting chip.

Preferably, further including:

an ultraviolet sensing element and a third transparent material, where the ultraviolet sensing element is disposed on the first surface, and the third transparent material covers the ultraviolet sensing element.

Preferably, further including:

an infrared (IR) identifying light emitting element and a third transparent material, where the IR identifying light emitting element is disposed on the first surface, and the third transparent material covers the IR identifying light emitting element, and the light sensing element receives an infrared light emitted by the IR identifying light emitting element.

Preferably, the wavelength of the infrared light is 750 nm-850 nm, and preferably is 810 nm.

Preferably, further including:

a biomedical sensing module and a third transparent material, where the biomedical sensing module is disposed on the first surface, and the third transparent material covers the biomedical sensing module, and a wavelength of light emitted or received by the biomedical sensing module is 495 nm-570 nm.

Preferably, further including:

a breathing lamp and a third transparent material, where the breathing lamp is disposed on the first surface, and the third transparent material covers the breathing lamp; and

the breathing lamp includes at least more than one of the following light emitting chips:

red (R) light emitting chip, green (G) light emitting chip, blue (B) light emitting chip and white (W) light emitting chip.

Preferably, the non-translucent substrate includes a metal substrate, a printed circuit board, a soft printed circuit board, a ceramic substrate, a resin substrate, a copper foil substrate or a combined substrate thereof.

Preferably, the material of the first transparent material includes epoxy, rubber or silicone.

Preferably, the material of the second transparent material includes epoxy, rubber or silicone.

Preferably, the material of the third transparent material includes epoxy, rubber or silicone.

Preferably, the first transparent material protrudes on the first surface and has a curved surface.

The present invention further provides a light emitting sensing device including:

a non-translucent substrate, having a first surface with at least one recess formed on the first surface;

a light emitting element, being disposed in the at least one recess;

a light sensing element, being disposed on the first surface;

a color sensor disposed on the first surface;

where, the color sensor has a sensing region, the sensing region includes: a red (R) sensing region, a green (G) sensing region, a blue (B) sensing region, a white (W) sensing region and an infrared (IR) sensing region.

Preferably, the R sensing region, the G sensing region, the B sensing region, the W sensing region and the IR sensing region form a sensing matrix in a parallel and bisymmetric manner, and the R sensing region, and the G sensing region, the B sensing region and the W sensing region are symmetrically distributed with respect to the IR sensing region in the sensing matrix, or,

one of the R sensing region, the G sensing region, the B sensing region, the W sensing region and the IR sensing region is positioned as a center of a circle, and the remaining four sensing regions are symmetrically and radially distributed around the center.

Preferably, an R transparent sheet is disposed on the R sensing region, and a waveband sensed by the R sensing region is 590 nm-750 nm.

a G transparent sheet is disposed on the G sensing region, and a waveband sensed by the G sensing region is 495 nm-590 nm;

a B transparent sheet is disposed on the B sensing region, and a waveband sensed by the B sensing region is 380 nm-495 nm;

an IR transparent sheet is disposed on the IR sensing region, and a waveband sensed by the IR sensing region is 750 nm-1100 nm;

a W transparent sheet is disposed on the W sensing region, and a waveband sensed by the W sensing region is 380 nm-750 nm.

Preferably, further including: a transparent material, where the transparent material is disposed in the recess and on the first surface, and covers the light emitting element, the light sensing element and the color sensor.

Preferably, the color sensor further includes: a processing unit, the sensing region is located on the processing unit, and a plurality of pins for current and signal processing is disposed on the processing unit.

Preferably, a ratio of a length to a width of the sensing region is 9:4; and

a ratio of the length of the sensing region to a length of the processing unit is 1:2;

a ratio of the width of the sensing region to a width of the processing unit is 1:7.

The invention also provides a method for manufacturing a light emitting sensing device, including:

partitioning a plurality of setting regions on a non-translucent substrate, each of the setting regions having a first surface;

forming a recess on the first surface in each of the setting regions by a first means;

disposing a light emitting element in the recess and disposing a light sensing element on the first surface in each of the setting regions;;

covering the light emitting element with a first transparent material and covering the light sensing element with a second transparent material in each of the setting regions; and

cutting the non-translucent substrate by a second means to separate these setting regions.

Preferably, the first means includes drilling, lasering or etching.

Preferably, the second means includes lasering cutting.

Preferably, further including:

disposing a color sensor on the first surface;

covering the color sensor with a third transparent material.

The light emitting sensing device provided in this embodiment includes a non-translucent substrate, and at least one recess is disposed on the first surface of the non-translucent substrate; a light emitting element is disposed in the at least one recess; a light sensing element disposed on the first surface; a first transparent material disposed on the at least one recess and covering the light emitting element; and a second transparent material disposed on the first surface and covering the light sensing element, such that the non-translucent substrate can prevent the light emitted by the light emitting element from being irradiated into the light sensing element, that is, avoiding the interference from the light emitted by the light emitting element with the light sensing element. Meanwhile, since the present application adopts a non-translucent substrate provided with a recess for placing a light emitting element, so that it is not necessary to provide a packaging glue between the light sensing element and the light emitting element. Therefore, the packaging procedure of the light emitting sensing device requires die pressing and cutting process for one time so as to avoid a secondary die pressing and a secondary cutting process applied in prior art, thereby simplifying the packaging procedures and reducing the process cost of the light emitting sensing device of the present application. Therefore, the light emitting sensing device provided by the present embodiment solves the problem that in the prior art, the infrared lights emitted by the light emitting chip causes interference with the light sensing chip resulting in reduced sensing accuracy.

In order make the above objects, technical features and advantages more obvious and understandable, the following is a detailed description in light of the preferred embodiments and the accompanying drawings.

### BRIEF DESCRIPTION OF DRAWINGS

In order to clearly illustrate the technical solutions in the embodiments of the present invention or in the prior art, the accompanying drawings used in the description of the embodiments or the prior art will be briefly described below. Obviously, the accompanying drawings in the following description are some embodiments of the present invention. For those skilled in the art, other drawings may also be obtained based on these drawings without any creative efforts.

FIG. 1A is a flowchart for manufacturing an existing ambient light and distance sensor;

FIG. 1B is a schematic structural diagram of an existing ambient light and distance sensor;

FIG. 2A is a schematic structural diagram of a light emitting sensing device according to a first embodiment of the present invention;

FIG. 2B is a cross-sectional schematic structural diagram taken along line B-B in FIG. 2A;

FIG. 3A is a schematic structural diagram of a light emitting sensing device according to a second embodiment of the present invention;

FIG. 3B is a cross-sectional schematic structural diagram taken along line B-B in FIG. 3A;

FIG. 3C is a schematic diagram of arrangement of each sensing region in a color sensor in a light emitting sensing device according to a second embodiment of the present invention;

FIG. 3D is a cross-sectional schematic diagram of a color sensor in a light emitting sensing device according to a second embodiment of the present invention;

FIG. 3E is a schematic diagram of a test of the light sensitivity of a color sensor in a light emitting sensing device according to a second embodiment of the present invention;

FIG. 3F is a schematic structural diagram of a color sensor in a light emitting sensing device according to a second embodiment of the present invention;

FIG. 4 is a schematic structural diagram of a light sensing element in a light emitting sensing device according to the present invention;

FIG. 5A is a schematic diagram of forming a recess on a non-translucent substrate in the method for manufacturing a light emitting sensing device according to the present invention;

FIG. 5B is a schematic diagram of disposing a light emitting element and a light sensing element on a non-translucent substrate in the method for manufacturing a light emitting and sensing device according to the present invention;

FIG. 5C is a schematic diagram of respectively covering a first transparent material and a second transparent material on a light emitting element and a light sensing element in the method for manufacturing a light emitting sensing device according to the present invention;

FIG. 5D is a schematic diagram of cutting a non-translucent substrate in the method for manufacturing a light emitting sensing device according to the present invention.

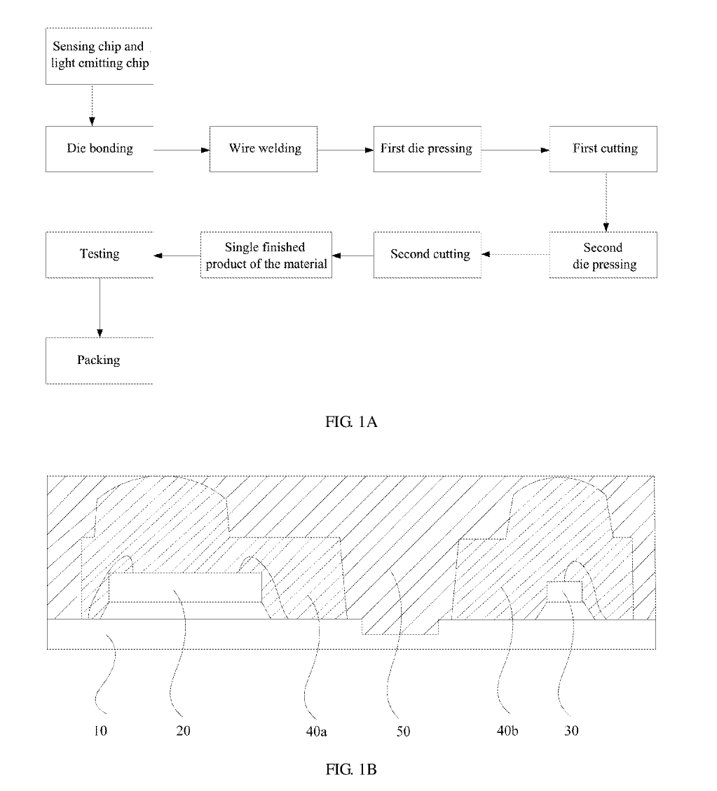

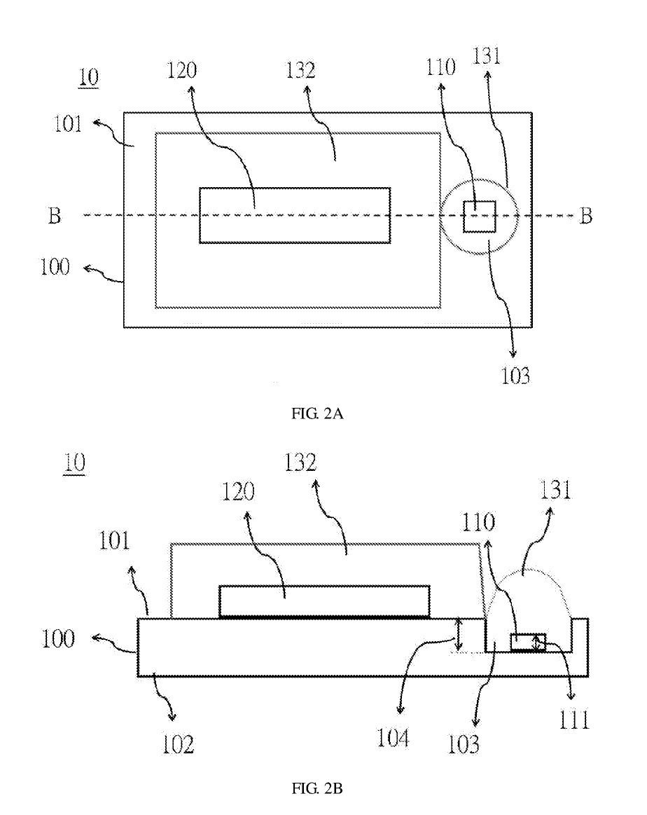

Description of the References:

| | | | |
|---|---|---|---|
| Light emitting | 10, 20 | Third transparent | 233 |
| sensing device | | material | |
| Non-translucent | 100, 200 | Color sensor | 240 |
| substrate | | | |
| First surface | 101, 201 | W sensing region | 241 |
| Second surface | 102, 202 | W transparent sheet | 241a |
| Recess | 103, 203 | B sensing region | 242 |
| Depth of recess | 104 | B transparent sheet | 242a |
| Light emitting | 210 | IR sensing region | 243 |
| element | | | |
| Height of light | 111 | IR transparent sheet | 243a |
| emitting element | | | |
| Light sensing | 120, 220 | R sensing region | 244 |
| element | | | |
| First transparent | 131, 231 | R transparent sheet | 244a |
| material | | | |
| Second transparent | 132, 232 | G sensing region | 245 |
| material | | | |
| Power supplying pin | 121 | G transparent sheet | 245a |
| (Power supply, VDD) | | | |
| Clock signal | 122 | Light blocking | 246 |
| inputting pin (IC data | | structure | |
| input/output terminal, | | | |
| SDA) | | | |
| Grounding pin | 123 | Application-specific | 247 |
| (Ground, GND) | | integrated circuit | |
| Data | 124 | Substrate | 248 |
| inputting/outputting | | | |
| pin (IC derail clock | | | |
| input terminal, SCL) | | | |
| Interrupting pin | 125 | Sensing region | 249 |
| (Interrupt output pin, | | | |
| INT) | | | |
| Current driving pin | 126 | VCC pin | 2401 |
| of IR light emitting | | | |
| element (IR LED | | | |
| sink current driver, | | | |
| IRDR) | | | |
| First light sensing | 151 | GND pin | 2402 |
| unit | | | |
| Second light sensing | 152 | INT pin | 2403 |
| unit | | | |
| Processing unit | 153, 240a | SDA pin | 2404 |
| Setting region | 160 | SCL pin | 2405 |

### DESCRIPTION OF EMBODIMENTS

To make the object, technical solutions, and advantages of the embodiments of the present invention more clear, the following clearly describes the technical solutions in the embodiments of the present invention with reference to the accompanying drawings in the embodiments of the present invention. Obviously, the described embodiments are a part of the embodiments of the present invention, not all of them. All other embodiments obtained by a person of ordinary skill in the art based on the embodiments of the present invention without creative efforts shall fall within the protection scope of the present invention.

### Embodiment 1

FIG. 2A is a schematic structural diagram of a light emitting sensing device according to a first embodiment of the present invention, and FIG. 2B is a cross-sectional schematic structural diagram taken along line B-B in FIG. 2A.

The light emitting sensing device 10 provided by the present invention is, for example, an trinity Ambient Light and Proximity Module (APM), combining an Ambient Light Sensor (ALS), a Proximity Module (PM) and Infrared Radiation (IR) light emitting diode (LED). The light emitting sensing device 10 provided in this embodiment is often used in smart mobile devices, such as smart phones. When a user is making a call and the face thereof approaches the device, the device will automatically turn off the display screen and the touch function, and only after the face of the user moves away from the device, the display screen and the touch function will be activated automatically, thereby saving power consumption of the device and preventing unintended activation when the user is talking on the phone.

Another important application of the present invention is security monitoring. A surveillance camera adopts the ALS can detect whether the ambient light is sufficient or not, and once the days are darker or the light is insufficient at nightfall, the IR LED carried on the surveillance camera can timely supplement the light to facilitate the detection.

An ambient light sensor (ALS) is one of light sensors, and it can measure the amount of ambient light and perceive the light intensity with responding characteristics similar to human eyes and then adjust the illuminance automatically. An ALS product adopts a waveband of 550 nm that is close to the spectral sensitivity of human eyes. A structure of an analog ALS comprises a photodiode and a current amplification IC, and it can suppress noise interference and accurately output a clear signal. A digital ALS supports an Inter-Integrated Circuit (I²C) digital communication interface, and it also has the feature of reducing the noise.

The ALS has been widely used in smart mobile devices nowadays, and it adjusts the backlight illuminance of the display screen depending on the ambient light to remarkably reduce the fatigue and discomfort of the human eyes. “The ALS plays an important role in people's life mainly for two reasons, one of which is that the ALS saves power consumption,” and “another reason is that the ALS provides more abundant functionalities” in addition to effectively saving energy and avoiding unnecessary waste. Any application related to ambient light sensing and requiring automatic adjustment of illuminance belongs to the ALS application fields. Meanwhile, the ALS is also applicable to extended applications such as development of Internet of Things, and smart cities or the like.

Street lamps adopting the ALS can automatically detect the sunlight to automatically adjust the illuminance depending on the brightness of the day, and automatic activation and deactivation of head lamps for vehicles are also the same application. Other hot applications also include a solar energy system, in which the ALS is applied to a solar farm so that solar panels rotate precisely to an energy collection angle with a higher efficiency depending on the orientation of the sun, thereby preventing the solar energy that can be collected from being reduced due to inaccurate rotating angle of the solar panels.

Referring to FIG. 2A to FIG. 2B, in this embodiment, the light emitting sensing device 10 includes: a non-translucent substrate 100, a light emitting element 110, a light sensing element 120, a first transparent material 131, and a second transparent material 132, where the non-translucent substrate 100 has a first surface 101 and a second surface 102, and the first surface 101 has at least one recess 103. The light emitting element 110 is disposed in the at least one recess 103; the light sensing element 120 is disposed on the first surface 101; the first transparent material 131 is disposed in at least one recess 103 and covers the light emitting element 110; and the second transparent material 132 is disposed on the first surface 101 and covers the light sensing element 120. In the embodiment, by using the non-translucent substrate 100 and providing a recess 103 for placing the light emitting element 110 on the non-translucent substrate 100, such that, even if the light emitting element 110 emits infrared light, the infrared light emitted by the light emitting element 110 cannot easily penetrate the non-translucent substrate 100 causing interference with the light sensing element 120 because the light emitting element 110 is located in the recess 103 and the substrate is the non-translucent substrate 100, that is, the non-translucent substrate 100 can prevent light emitted by the light emitting element 110 from being irradiated into the light sensing element 120. While in the prior art, the infrared light emitted by the light emitting chip can easily penetrate the substrate and the packaging glue to cause interference with the light sensing chip. Therefore, the light emitting sensing device 10 provided in this embodiment uses the non-translucent substrate 100 and providing a recess 103 for placing the light emitting element 110 on the non-translucent substrate 100 to make the light emitted by the light emitting element 110 cannot easily being irradiated into the light sensing element 120, that is to avoid the interference from the infrared light emitted by the light emitting element 110 with the light sensing element 120, thereby ensuring the sensing accuracy of the light emitting sensing device 10.

Meanwhile, in this embodiment, when the non-translucent substrate 100 is used and the recess 103 is formed on the non-translucent substrate 100, during packaging, only the first transparent material 131 and the second transparent material 132 are required to respectively cover the light emitting element 110 and the light sensing element 120 to complete a die pressing, and then perform cutting to obtain a single finished product.

Compared with secondary die pressing and secondary cutting performed in the prior art, the light emitting sensing device 10 provided in this embodiment effectively simplifies the packaging procedure and reduces the process cost.

Where, in this embodiment, the non-translucent substrate 100 is a non-translucent substrate 100 of a single composition or a substrate 100 formed by mixing multiple compositions at several proportions and includes a metal substrate, a printed circuit board, a soft printed circuit board, a ceramic substrate, a resin substrate, a copper foil substrate or other types of substrates and a combination thereof. An opening is formed by digging at a die bonding position (the opening may be formed by drilling, lasering, etching or the like, but not limited thereto, and the shape of the opening may be a rectangle, a circle or a polygon), and the encapsulating adhesive may include epoxy, rubber, silicone and a combination thereof. A sample can be obtained simply by encapsulating with the adhesive and cutting after the welding process is finished.

Where, in this embodiment, the shape of the opening of the recess 103 is specifically a rectangle, a circle or a polygon.

Where, in this embodiment, it should be noted that the light sensing element 120 may also be disposed in the recess 103, and the light emitting element 110 may be disposed on the first surface 101 so that the non-translucent substrate 100 can prevent the light emitted by the light emitting element 110 from being irradiated into the light sensing element 120.

The light emitting sensing device 10 provided in this embodiment includes a non-translucent substrate 100, and at least one recess 103 is disposed on the first surface 101 of the non-translucent substrate 100; a light emitting element 110 disposed in the at least one recess 103; a light sensing element 120 disposed on the first surface 101; a first transparent material 131 disposed on the at least one recess 103 and covering the light emitting element 110; and a second transparent material 132 disposed on the first surface 101 and covering the light sensing element 120, such that the non-translucent substrate 100 can prevent the light emitted by the light emitting element 110 from being irradiated into the light sensing element 120, that is, avoiding the interference from the light emitted by the light emitting element 110 with the light sensing element 120. Meanwhile, since the present application adopts a non-translucent substrate 100 provided with a recess 103 for placing a light emitting element 110, so that it is not necessary to provide packaging glue between the light sensing element 120 and the light emitting element 110. Therefore, the encapsulating procedure of the light emitting sensing device 10 requires die pressing and cutting process for one time so as to avoid a secondary die pressing and a secondary cutting process applied in prior art, thereby simplifying the packaging procedures and reducing the process cost for the light emitting sensing device 10 of the present application. Therefore, the light emitting sensing device 10 provided by the present embodiment realizes simplified encapsulating procedures and solves the problem that in the prior art, the infrared light emitted by the light emitting chip causes interference with the light sensing chip resulting in reduced sensing accuracy.

Further, based on the embodiments aforementioned, in the present embodiment, in order to further prevent light emitted by the light emitting element 110 from being irradiated into the light sensing element 120, specifically, as shown in FIG. 2B, the depth 104 of the recess 103 is 2 to 4 times of the height 111 of a light emitting element 110. For example, the depth 104 of the recess 103 is 3 or 2.5 times of the height 111 of a light emitting element 110. For example, if the height 111 of the light emitting element 110 is 2 nm, the depth 104 of the recess 103 is 4 nm-8 nm. Where the specific multiple relation is selected according to actual application, as long as the light emitted by the light emitting element 110 does not irradiate into the light sensing element 120, so that interference from light emitted by the light emitting element 110 with the light sensing element 120 can be prevented.

Where, in this embodiment, it should be noted that the flexible adjustment and design may be achieved by matching the depth 104 of the recess 103 and the height 111 of the light emitting element 110 with the emitting angle of the light emitting element 110, the relative position and distance between the light emitting element 110 and the light sensing element 120. That is, in the present embodiment, the depth of the recess 103 and the height 111 of the light emitting element 110 are not limited to 2 to 4 times.

Further, based on the embodiments aforementioned, in the present embodiment, in order to ensure the optical rotation blocking performance of the non-translucent substrate 100, in this embodiment, the non-translucent substrate 100 includes a light absorbing material, and the light absorbing material is specifically a black material. In this way, the transmittance of the non-translucent substrate 100 can be reduced. Specifically, in this embodiment, the light reflectance of the non-translucent substrate 100 is 0%-10%, and the light transmittance of the non-translucent substrate 100 is 0%-5%, which can prevent the interference from the infrared light emitted by the light emitting element 110 with the light sensing element 120.

Further, based on the embodiments aforementioned, in this embodiment, the light emitting element 110 includes a light emitting diode for emitting infrared light, that is, the light emitting diode is specifically an infrared light emitting diode (IR LED), where, in the present embodiment, the light emitting element 110 further includes a laser element. The laser element may include a laser diode and a Vertical-Cavity Surface-Emitting Laser (VCSEL).

Further, based on the embodiments aforementioned, in this embodiment, the light sensing element 120 senses visible light and invisible light, that is, in the present embodiment, the light sensing element 120 can sense both visible light and invisible light. For example, the light sensing element 120 can sense infrared light. Specifically, in this embodiment, the light sensing element 120 includes a first light sensing unit 151, a second light sensing unit 152, and a processing unit 153, where the first light sensing unit 151 is configured to sense the visible light and output a corresponding sensing signal to the processing unit 153, and the second light sensing unit 152 is configured to sense invisible light emitted by the light emitting element 110 and output a corresponding sensing signal to the processing unit 153, such that the light emitting sensing device 10 provided by this embodiment can sense ambient light, and can also sense invisible light by cooperating with the light emitting element 110.

Further, based on the embodiments aforementioned, in this embodiment, the first light sensing unit 151 is an ambient light sensing unit, and the second light sensing unit 152 is a distance sensing unit, so that the light emitting sensing device 10 provided by this embodiment can sense ambient light and also can sense the distance by cooperating with the light emitting element 110. That is, the light sensing device 10 is a trinity (ambient light, distances and IR LED) light sensing module.

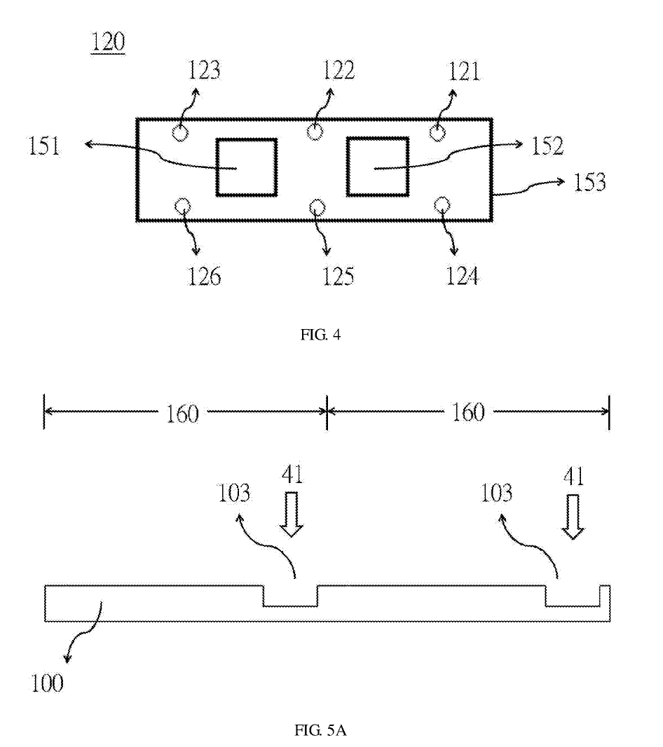

In this embodiment, pins are disposed on the processing unit 153 of the light sensing element 120, as shown in FIG. 4, including a power supplying pin (Power supply, VDD) 121 and clock signal inputting pin (C data input/output terminal, SDA) 122, grounding pin (Ground, GND) 123, data inputting/outputting pin (IC derail clock input terminal, SCL) 124, interrupting pin (Interrupt output pin, INT) 125, and current driving pin of IR light emitting element (IR LED sinkcurrent driver, IRDR) 126.

Further, based on the embodiments aforementioned, in the present embodiment, the wavelength of visible light sensed by the ambient light sensing unit is 400 nm-700 nm, and the wavelength of the invisible light emitted by the light emitting element 110 sensed by the distance sensor unit is 800 nm-1100 nm. That is, in this embodiment, the wavelength of the invisible light emitted by the light emitting element 110 is 800 nm-1100 nm. For example, the wavelength may be 810 nm, 900 nm, or the like.

Further, based on the embodiments aforementioned, in the present embodiment, the material of the first transparent material 131 includes epoxy, rubber or silicone, and the material of the second transparent material 132 includes epoxy, rubber or silicone. Where, when the first transparent material 131 is disposed on the first surface 101, the first transparent material 131 protrudes on the first surface 101 and has a curved surface. The first transparent material 131 and the second transparent material 132 do not contact with each other.

### Embodiment 2

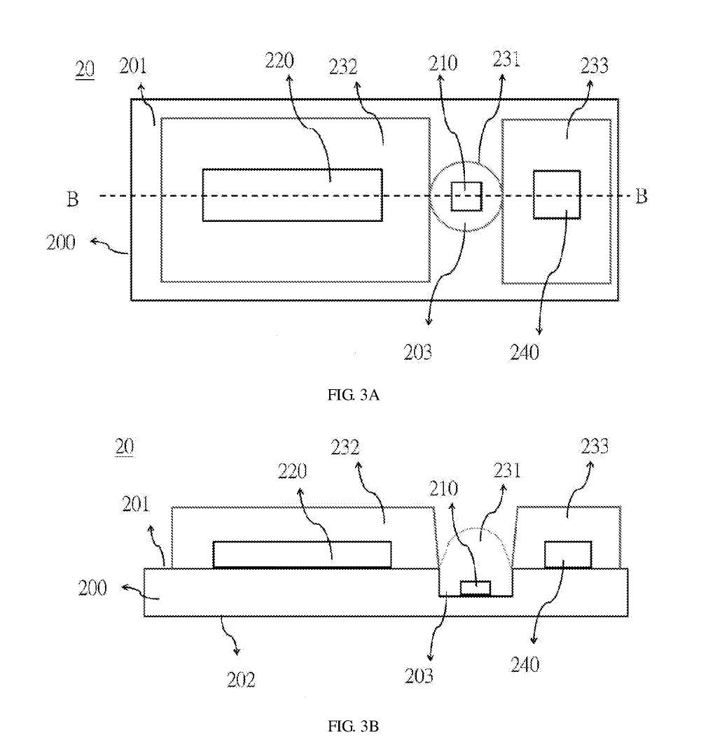

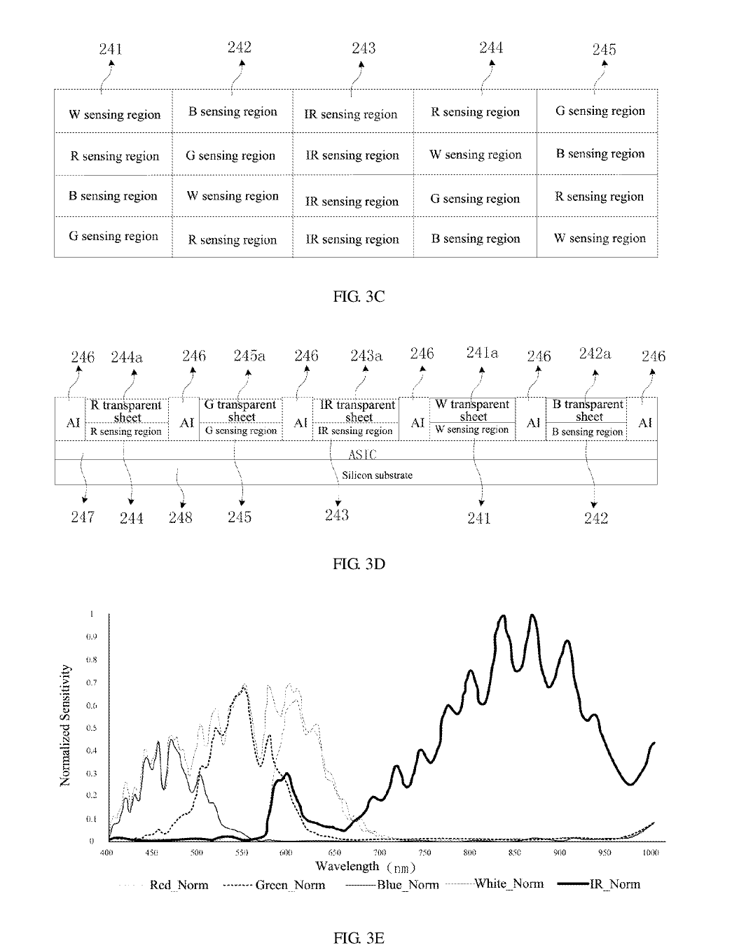

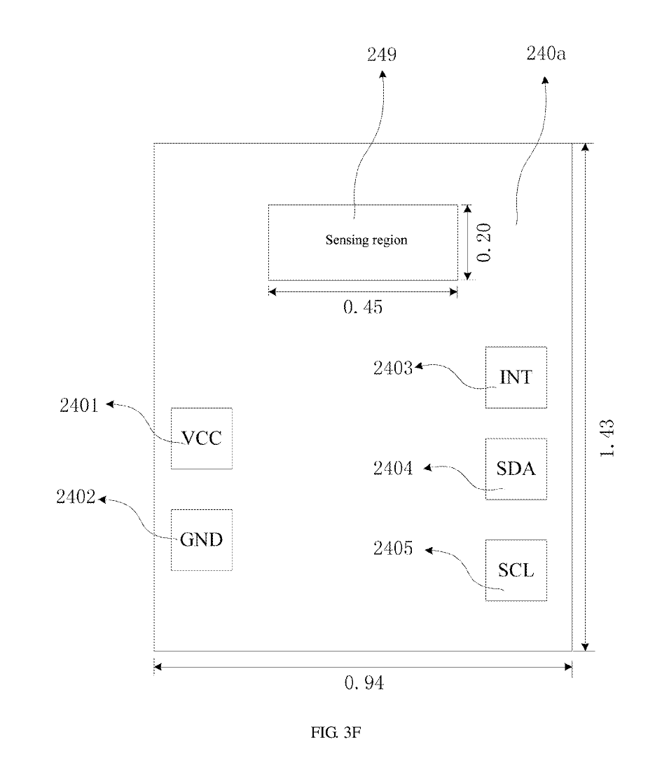

FIG. 3A is a schematic structural diagram of a light emitting sensing device according to a second embodiment of the present invention; FIG. 3B is a cross-sectional schematic structural diagram taken along line B-B in FIG. 3A; FIG. 3C is a schematic diagram of arrangement of each sensing region in a color sensor in a light emitting sensing device according to a second embodiment of the present invention; FIG. 3D is a cross-sectional schematic diagram of a color sensor in a light emitting sensing device according to a second embodiment of the present invention; FIG. 3E is a schematic diagram of a test of the light sensitivity of a color sensor in a light emitting sensing device according to a second embodiment of the present invention; and FIG. 3F is a schematic structural diagram of a color sensor in a light emitting sensing device according to a second embodiment of the present invention.

Where the light emitting sensing device 20 provided in this embodiment, as shown in FIG. 3B, includes: a non-translucent substrate 200, a light emitting element 210, a light sensing element 220, a first transparent material 231, and a second transparent material 232, where the non-translucent substrate 200 has a first surface 201 and a second surface 202, and the first surface 201 has at least one recess 203. The light emitting element 210 is disposed in the at least one recess 203; the light sensing element 220 is disposed on the first surface 201; the first transparent material 231 is disposed in at least one recess 203 and covers the light emitting element 210; and the second transparent material 232 is disposed on the first surface 201 and covers the light sensing element 220.

Where, in order to increase functions of the light emitting sensing device 20, further including: an electronic element disposed on the first surface 101. Specifically, in this embodiment, the electronic element is a color sensor (Color Sensor, CLS) 240, that is, in this embodiment, the light emitting sensing device 20 further includes a color sensor 240 and a third transparent material 233. The color sensor 240 is disposed on the first surface 201, and the third transparent material 233 covers the color sensor 240. As shown in FIG. 3B, the color sensor 240 and the light sensing element 220 are located on both sides of the light emitting element 210. Where, in the present embodiment, the color sensor 240 (CLS), belonging to a high-level ALS product and adopts a high resolution specification of 16 bits, and the CLS not only can detect the light intensity, but also can detect the intensity respectively of red, blue and green lights. If the CLS is applied to the security monitoring system in an airport, the CLS can feed the ambient illumination condition back into an image processing system and enhance the color of the clothes of a target object to be detected to obtain important color information required during the tracking of the object. Also, the CLS is often used for production lines, and once a product having a different color is detected during the production, the operation of the production line will be suspended immediately, thereby ensuring that all the products are consistent in color standard.

Where, in this embodiment, the third transparent material 233 is specifically epoxy, rubber or silicone, where when the third transparent material 233 is disposed on the first surface 101, the third transparent material 233 and the first transparent material 231 and the second transparent material 232 do not contact with each other.

Where, in this embodiment, the color sensor 240 includes a processing unit 240a and a sensing region 249. The sensing region 249 is located on the processing unit 240a. The sensing region 249 includes at least more than one of the following sensing regions: red (R) sensing region 244, green (G) sensing region 245, blue (B) sensing region 242, white (W) sensing region 241, infrared (IR) sensing region 243, and ultraviolet (UV) sensing region (not shown), that is, in the present embodiment, the color sensor 240 may include two or more of an R sensing region 244, a G sensing region 245, a B sensing region 242, a W sensing region 241, an IR sensing region 243, and a UV sensing region.

Where, in this embodiment, to avoid interference between adjacent sensing regions, as shown in FIG. 3D, a light blocking structure 246 is disposed between each two sensing region. The light blocking structure 246 is specifically made of metal or insulating material. That is, the light blocking structure 246 may be a metal part or an insulating part. In this embodiment, the light blocking structure 246 is preferably aluminum metal.

Where, in this embodiment, specifically, the sensing region 249 includes an R sensing region 244, a G sensing region 245, a B sensing region 242, a W sensing region 241, and an IR sensing region 243, that is, the color sensor 240 is a five-in-one (R, G, B, W and IR) sensor, where, in this embodiment, the sensing region 249 specifically includes a plurality of R sensing regions 244, a plurality of G sensing regions 245, a plurality of B sensing regions 242, the plurality of W sensing regions 241, and the plurality of IR sensing regions 243. In FIG. 3C, the sensing region 249 includes four R sensing regions 244, four G sensing regions 245, and four B sensing regions 242, four W sensing regions 241, and four IR sensing regions 243, where, in the present embodiment, in case of distribution of the R sensing region 244, the G sensing region 245, the B sensing region 242, the W sensing region 241, and the IR sensing region 243, specifically, as shown in FIG. 3C, the R sensing region 244, the G sensing region 245, the B sensing region 242, the W sensing region 241, and the IR sensing region 243 form a sensing matrix in a parallel and bisymmetric manner, and the R sensing region 244, the G sensing region 245, the B sensing region 242, and the W sensing region 241 in the sensing matrix are symmetrically distributed with respect to the IR sensing region 243, that is, the IR sensing region 243 is located in the central position, and the IR sensing region 244, the G sensing region 245, the B sensing region 242, and the W sensing region 241 are symmetrically positioned on both sides of the IR sensing region 243 in such a manner that regarding a double diagonal as an axis of symmetry. In the present embodiment, the above five sensing regions adopt the distribution of the sensing matrix aforementioned with better light sensing, so that a full range of sensing purposes can be realized for the color sensor 240. The five sensing regions enable the color sensor 240 to sense five wavebands so as to offer good color conformity and can be applied to various color test paper detections. In one embodiment, one waveband sensing region is located at a central location, and the other four waveband sensing regions are symmetrically positioned on both sides of the waveband IR sensing region 243 at the central location in such a manner that regarding a double diagonal as an axis of symmetry.

Where, in this embodiment, in addition to the arrangement aforementioned, the five sensing regions may also employ: one of the R sensing region 244, the G sensing region 245, the B sensing region 242, the W sensing region 241 and the IR sensing region 243 is positioned as a center of a circle, and the remaining four sensing regions are symmetrically and radially distributed around the center, for example, take the IR sensing region 243 as the center of the circle, and the R sensing region 244, the G sensing region 245, and the B sensing region. 242 and the W sensing region 241 are symmetrically and radially distributed around the IR sensing region 243. Such an arrangement may achieve a full range of sensing purpose.

Where, in this embodiment, specifically, as shown in FIG. 3D and FIG. 3F, an R transparent sheet 244a is disposed on the R sensing region 244 so that the waveband sensed by the R sensing region 244 is 590 nm-750 nm. A G transparent sheet 245a is disposed on the G sensing region 245 so that the waveband sensed by the G sensing region 245 is 495 nm-590 nm. A B transparent sheet 242a is disposed on the B sensing region 242 so that the waveband sensed by the B sensing region 242 is 380 nm-495 nm. An IR transparent sheet 243a is disposed on the IR sensing region 243 so that the waveband sensed by the IR sensing region 243 is 750 nm-1100 nm. A W transparent sheet 241a is disposed on the W sensing region 241 so that the waveband sensed by the sensing region 241 is 380 NM-750 nm. That is, in this embodiment, the color sensor 240 includes five sensing regions, each of which can sense one waveband. The sensing waveband includes red light, green light, blue light, white light, and infrared light, that is, the waveband sensed by the color sensor 240 is a five-in-one sensing waveband, so that the color sensor 240 can offer good color conformity and can be applied to various color test paper detections. In this way, the color sensor 240 can be configured to detect ambient light signals, and the detection of ambient light is more accurate. Where, the improved color sensor 240 in this embodiment may be used for reflective sensing or transmissive sensing.

Where, in addition to the sensing regions, a plurality of pins for processing current and signals is disposed on the processing unit 240a of the color sensor 240 provided in this embodiment. The plurality of pins is, for example, the VCC (Power supply) pin 2401, the NC (Empty pin) pin (not shown), the GND (Ground) pin 2402, the INT (Interrupt function) pin 2403, the SDA (Data transfer) pin 2404, and the SCL (Clock transfer) pin 2405. Where, SDA pin 2404 and SCL pin 2405 can be I²C bus specification. In an embodiment, the color sensor 240 further includes a programmable gain amplifier (Programmable gain amplifier, PGA), an analog-to-digital conversion unit, an application-specific integrated circuit 247 (application-specific integrated circuit, ASIC), and an input/output interface (IO interface), an oscillator, a dark current compensation unit, and a temperature detection unit. At the same time, the color sensor 240 further includes a substrate 248. The substrate 248 may specifically be a silicon substrate, and the application-specific integrated circuit 247 is disposed on the substrate 248. The R sensing region 244, the B sensing region 242, the G sensing region 245, the W sensing region 241, and the IR sensing region 243 are all electrically connected to the application-specific integrated circuit 247.

Where, it is verified by the illuminance/color temperature measurement that the color temperature error of the color sensor 240 is below 400 K (the standard is 500 K) and the illuminance error is 5%, that is, the color sensor 240 can effectively filter other stray light and obtain an accurate color temperature and illuminance

At the same time, as shown in FIG. 3F, when the color sensor performs light sensing to each light, the light sensitivity is high, which ensures better light sensing accuracy for the color sensor.

### Embodiment 3

The difference between the present embodiment and the embodiment 2 is that in this embodiment, the electronic element further included in the light emitting sensing device 20 is specifically a multichip light emitting element, that is, in this embodiment, the light emitting device 20 further includes: a multichip light emitting element and a third transparent material 233. The multichip light emitting element is disposed on the first surface 201, and the third transparent material 233 covers the multichip light emitting element. Where, the third transparent material 233 is specifically epoxy, rubber or silicone. Where, when the third transparent material 233 is disposed on the first surface 101, the third transparent material 233, the first transparent material 231 and the second transparent material 232 do not contact with each other.

Where, in this embodiment, the multichip light emitting element 110 includes at least more than one of the following light emitting chips: R (red) light emitting chip, G (green) light emitting chip, B (blue) light emitting chip, W (white) light emitting chip, that is, the multichip light emitting element 110 includes at least more than one of the R, G, B and W light emitting chips. In this embodiment, the multichip light emitting element 110 can serve as a light source indicator for standby, charging, information notification or other function reminders of the device.

### Embodiment 4

The difference between the present embodiment and the above Embodiment 2 is that in this embodiment, the electronic element further included in the light emitting sensing device 20 is specifically an ultraviolet sensing element. That is, in this embodiment, the light emitting sensing device 10 further includes: a (UV) sensing element and a third transparent material 233, where the ultraviolet sensing element is disposed on the first surface 201, and the third transparent material 233 covers the ultraviolet sensing element, where the ultraviolet rays (UV) are divided into four wavebands according to wavelength; the wavelength of the UVA waveband is 320 nm-400 nm; the wavelength of the UVB waveband is 275 nm-320 nm; the wavelength of the UVC waveband is 200 nm-275 nm; and the wavelength of the UVD waveband is 100 nm-200 nm. While in this embodiment, UV light sensing elements may specifically be at least more than one of arbitrary combination design of the UVA, UVB and UVC, that is, the waveband sensed by the UV light sensing element may be at least more than one of UVA, UVB, or UVC wavebands.

### Embodiment 5

The difference between this embodiment and the above Embodiment 2 is that in this embodiment, the electronic element further included in the light emitting sensing device 20 is specifically an infrared (IR) identifying light emitting element. That is, in this embodiment, the light emitting device 20 further includes: an infrared (IR) identifying light emitting element and a third transparent material 233, where the IR identifying light emitting element is disposed on the first surface 201, and the third transparent material 233 covers the IR identifying light emitting element, where the light sensing element 220 receives an infrared light emitted by the IR identifying light emitting element. In this embodiment, the infrared light emitted by the IR identifying element is a high power infrared light (with a power greater than 0.5 W) with the wavelength ranging from 800 nm-1100 nm. For example, it can be 810 nm, 850 nm, and 940 nm, and can be used as an iris identification or face identification, that is, the light emitting sensing device 20 provided in this embodiment may have an function of iris identification or a face identification.

### Embodiment 6

The difference between this embodiment and the above Embodiment 2 is that in this embodiment, the electronic element further included in the light emitting sensing device 20 is specifically a biomedical sensing module, that is, in this embodiment, the light emitting sensing device 20 further includes: a biomedical sensing module and a third transparent material 233, where the biometric sensing module is disposed on the first surface 201, the third transparent material 233 covers the biomedical sensing module, and the wavelength of the light can be transmitted or received by the biomedical sensing module may is 495 nm-570 nm. Sensing of the biomedical sensing module can be used as a sensor for heartbeat, blood oxygen and blood glucose.

### Embodiment 7

The difference between this embodiment and the above Embodiment 2 is that in this embodiment, the electronic element further included in the light emitting sensing device 20 is specifically a breathing lamp, that is, in this embodiment, the light emitting sensing device 20 further includes: a breathing lamp and a third transparent material 233, where the breathing lamp is disposed on the first surface 201, the third transparent material 233 covers the breathing lamp, and the breathing lamp includes at least more than one of the following light emitting chips: the R light emitting chip, the G light emitting chip, the B light emitting chip and the W light emitting chip, that is, the breathing lamp, includes two or more of an R light emitting chip, a G light emitting chip, a B light emitting chip, and a W light emitting chip. For example, the breathing lamp may include an R light emitting chip and a B light emitting chip. That is, the breathing lamp can emit red light and blue light. Where, in this embodiment, the breathing lamp alerts the notifications including missed messages, missed calls, and unviewed messages in a flickering manner, that is, the breathing lamp enables the reminder function by flickering.

### Embodiment 8

This embodiment provides a light emitting sensing device, referring to FIG. 3A to FIG. 3F, specifically, the light emitting sensing device includes: a non-translucent substrate 100 having a first surface 101, and at least one recess 103 is disposed on the first surface 101;

a light emitting element 110 disposed in at least one recess 103; a light sensing element 120 disposed on the first surface 101; and a color sensor 240 disposed on the first surface 101. Where the color sensor 240 includes a processing unit 240a and a sensing region 249. The sensing region 249 is located on the processing unit 240a. Where, the sensing region 249 includes: R sensing region 244, G sensing region 245, B sensing region 242, W sensing region 241, IR sensing region 243, and UV sensing region, that is, the color sensor 240 provided in this embodiment is a five-in-one color sensor, which can be applied to various color test paper detections. Where, in this embodiment, there are a plurality of R sensing regions 244, G sensing regions 245, B sensing regions 242, W sensing regions 241, and IR sensing regions 243. As shown in FIG. 3C, the sensing region 249 includes four R sensing regions 244, four G sensing regions 245, four B sensing regions 242, four W sensing regions 241 and four IR sensing regions 243; where, in this embodiment, the arrangement of the R sensing region 244, the G sensing region 245, the B sensing region 242, the W sensing region 241 and the IR sensing region 244 may be referred to the embodiments aforementioned (as shown in FIG. 3C and FIG. 3D), for example, to form a sensing matrix in a parallel and bisymmetric manner, or are symmetrically distributed, which will not repeat in this embodiment.

As shown in FIG. 3F, the processing unit 240a of the color sensor 240 is specifically a rectangular. The processing unit 240a may have a length of 0.94 cm and a width of 1.43 cm; where, when the sensing region 249 is disposed on the color sensor 240, the sensing region 249 is specifically a rectangular region. Specifically, the ratio of the length to the width of the sensing region 249 is 9:4. For example, when the length of the sensing region 249 is 0.45 cm, the width is 0.2 cm. In another embodiment, the ratio of the length of the sensing region 249 to the length of the processing unit 240a is 1:2; the ratio of the width of the sensing region 249 to the width of the processing unit 240a is 1:7. Where, in this embodiment, the sensing region 249 is specifically a sensing region made up of an R sensing region 244, a G sensing region 245, a B sensing region 242, a W sensing region 241, and an IR sensing region 243.

Where, in this embodiment, a plurality of pins for processing current and signals is disposed on the processing unit 240a. As shown in FIG. 3F, the plurality of pins are, for example, the VCC (Power supply) pin 2401, the NC (Empty pin) pin (not shown), the GND (Ground) pin 2402, the INT (Interrupt function) pin 2403, the SDA (Data transfer) pin 2404, and the SCL (Clock transfer) pin 2405.

Where, for the light emitting and sensing device provided by this embodiment, since the light emitting element 110 is disposed in the recess 103 of the non-translucent substrate 100, the light emitted by the light emitting element 110 cannot easily being irradiated into the light sensing element 120 and the color sensor 240 under the blocking of the non-translucent substrate 100, so that the problem that the light emitted by the light emitting element 110 interferes with the light sensing element 120 and the color sensor 240 is avoided, thereby ensuring the sensing accuracy of the light emitting sensing device.

Where, in this embodiment, as shown in FIG. 3D, an R transparent sheet 244a is disposed on the R sensing region 244, and the waveband sensed by the R sensing region 244 is 590 nm-750 nm; a G transparent sheet 245a is disposed on the G sensing region 245, and the waveband sensed by the G sensing region 245 is 495 nm-590 nm; a B transparent sheet 242a is disposed on the B sensing region 242, and the waveband sensed by the B sensing region 242 is 380 nm-495 nm; an IR transparent sheet 243a is disposed on the IR sensing region 243, and the waveband sensed by the IR sensing region 243 is 750 nm-1100 nm; and a W transparent sheet 241a is disposed on the W sensing region 241, and the waveband sensed by the W sensing region 241 is 380 nm-750 nm.

Where, in this embodiment, further including: a transparent material disposed on the recess 103 and on the first surface 101, and covers the light emitting element 110; a light sensing element 120 and a color sensor 240. The arrangement of the transparent material may refer to that of the first transparent material 131, the second transparent material 132 and the third transparent material 233 in above embodiments, and the transparent material includes specifically epoxy, rubber or silicone.

Where, in this embodiment, the non-translucent substrate 100 may be a non-translucent substrate 100 of a single composition or a substrate 100 formed by mixing multiple compositions at several proportions and includes a metal substrate, a printed circuit board, a soft printed circuit board, a ceramic substrate, a resin substrate, a copper foil substrate or other types of substrates and a combination thereof. An opening is formed by digging at a die bonding position (the opening may be formed by drilling, lasering, etching or the like, but not limited thereto, and the shape of the opening may be a rectangle, a circle or a polygon), and the encapsulating adhesive may include epoxy, rubber, silicone and a combination thereof. A sample can be obtained simply by encapsulating with the adhesive and cutting after the welding process is finished.

### Embodiment 9

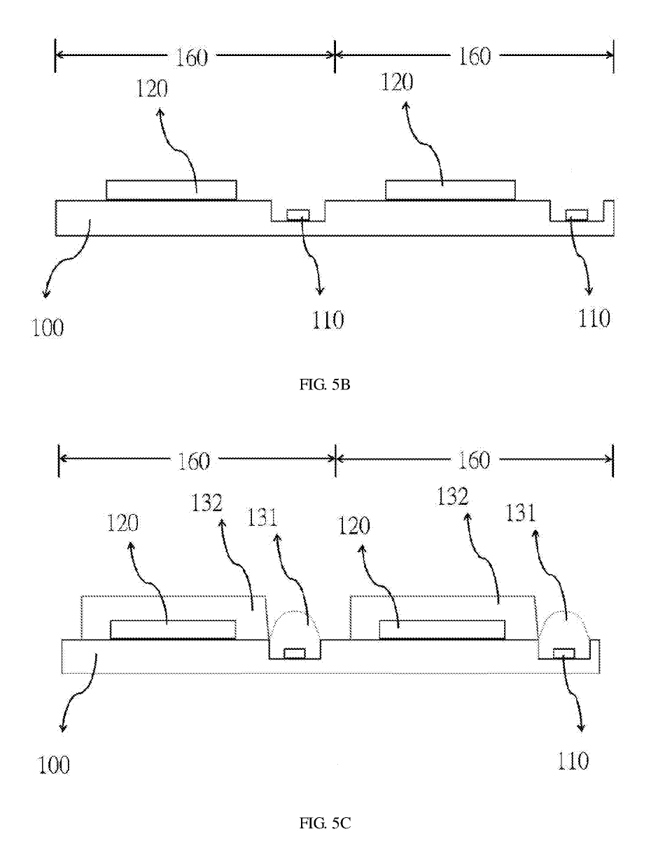

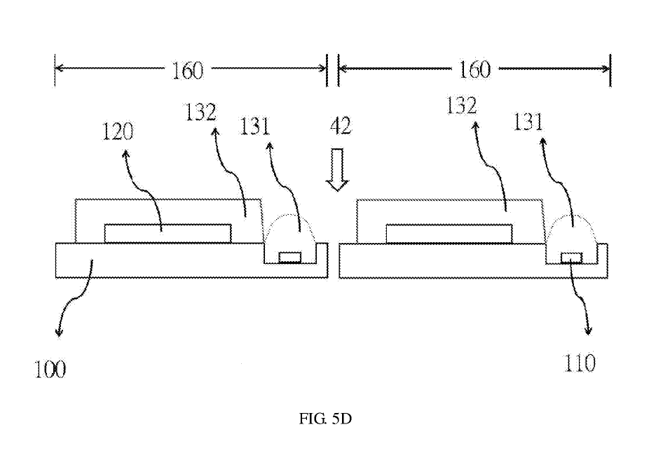

FIG. 5A is a schematic diagram of forming a recess on a non-translucent substrate in the method for manufacturing a light emitting sensing device according to the present invention; FIG. 5B is a schematic diagram of disposing a light emitting element and a light sensing element on a non-translucent substrate in the method for manufacturing a light emitting and sensing device according to the present invention; 5C is a schematic diagram of a substrate, FIG. 5C is a schematic diagram of respectively covering a first transparent material and a second transparent material on a light emitting element and a light sensing element in the method for manufacturing a light emitting sensing device according to the present invention; and FIG. 5D is a schematic diagram of cutting a non-translucent substrate in the method for manufacturing a light emitting sensing device according to the present invention.

This embodiment provides a method for manufacturing a light emitting sensing device 10, which is shown in FIG. 5A to FIG. 5D, including following steps:

Step 1): partitioning a plurality of setting regions 160 on a non-translucent substrate 100, each setting region 160 has a first surface 101;

Where, in this embodiment, the non-translucent substrate 100 includes a light absorbing material, so that the non-translucent substrate 100 has a low reflectance and a low light transmittance. Specifically, the light reflectance of the non-translucent substrate 100 is 0%-10%; the light transmittance of the non-translucent substrate 100 is 0%-5%. The non-translucent substrate 100 includes a metal substrate, a printed circuit board, a soft printed circuit board, a ceramic substrate, a resin substrate, a copper foil substrate or a combined substrate thereof.

Step 2): forming a recess 103 on the first surface 101 in each of the setting regions 160 by a first means 41;

As shown in FIG. 5A, a recess 103 is formed on the first surface 101 of each setting region 160 by a first means 41, where the first means 41 includes, but is not limited to, drilling, lasering or etching. Where, in this embodiment, the shape of the recess 103 may specifically be a circle, a square or a polygon, and the depth of the recess 103 is specifically 2 to 4 times of the height of the light emitting element 110.

Step 3): disposing a light emitting element 120 in the recess 103 and disposing a light sensing element 110 on the first surface 101 in each of the setting regions 160;

As shown in FIG. 5B, one light emitting element 110 is disposed in each recess 103, and a light sensing element 120 is disposed on the first surface 101 of each setting region 160, where, in this embodiment, refer to the description in the above embodiments for the structure of the light emitting element 110 and the light sensing element 120 specifically, and the structure and performance of the light emitting element 110 and the light sensing element 120 will not be repeat in this embodiment.

Step 4): covering the light emitting element 110 with a first transparent material 131 and covering the light sensing element 120 with a second transparent material 132 in each of the setting regions 160;

Where, as shown in FIG. 5C, in this embodiment, the first transparent material 131 and the second transparent material 132 cover the light emitting element 110 and the light sensing element 120 to complete the die pressing.

Step 5): cutting the non-translucent substrate 100 by a second means 42 to separate these setting regions.

Where, as shown in FIG. 5D, in this embodiment, the second means 42 includes, but is not limited to, laser cutting, that is, laser cutting can be used to cut each setting region 160 on the non-translucent substrate 100 to obtain single finished product.

In this embodiment, by providing a recess 103 on the non-translucent substrate 100, which can obtain a single finished product simply by molding and cutting for one time. However, in the prior art, secondary laminating film and secondary cutting are required. Therefore, compared with the prior art, the manufacturing method provided in this embodiment simplifies the manufacturing procedures, thereby reducing the process cost. At the same time, in the manufactured light emitting sensing device 10, since the non-translucent substrate 100 can prevent the light emitting by the light emitting element 110 from being irradiated into the light sensing element 120, so that the problem that the light emitted by the light emitting element 110 interferes with the light sensing element 120 is avoided, thereby achieving accurate sensing.

Further, in this embodiment, in step 3), the method further includes following steps: disposing a color sensor 240 on the first surface 101; covering the color sensor 240 with a third transparent material 233, a third transparent material 233 is covered on the color sensor 240, that is, in the present embodiment, the manufactured light emitting sensing device 10 further includes a color sensor 240, so that the manufactured light emitting sensing device 10 integrates three functions of ambient light sensing, distance sensing, and color sensing. Where, in the embodiments, the structure of the color sensor 240 may refer to that in the above embodiments, which will not repeat in this embodiment.

In the description of the present invention, it is appreciated that the orientation or positional relationship indicated by terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, etc. is based on the orientation or positional relationship shown in the accompanying drawings, and is merely to facilitate and simplify the description of the present invention, rather than indicating or implying that the device or component referred to must have a particular orientation, be constructed and operated in a particular orientation, and thus should not be construed as limiting the present invention.

In the description of the present invention, it is appreciated that terms “including” and “having” and any variations thereof as used herein are intended cover a non-exclusive inclusion, for example, processes, methods, products, or devices including a series of steps or units are not necessarily limited to those steps or units that are explicitly listed, but may include other steps or units that are not explicitly listed or inherent to these processes, methods, products, or devices.

Unless expressly specified or limited otherwise, terms “mounted,” “connected”, “connection”, “fixed”, etc. shall be interpreted broadly and may be, for example, a fixed connection, a removable connection, or to be an integration; it may be directly connected, it can also be indirectly connected through the intermediary, it can interconnect the two components, or it is the interaction between two components. For those of ordinary skill in the art, the specific meanings of the above terms in the present invention can be understood according to specific circumstances. Moreover, terms “first”, “second”, etc. are used for descriptive purposes only, and are not to be construed as indicating or implying relative importance or implicitly indicating the number of indicated technical features.

Finally, it should be noted that the above embodiments are only used to illustrate the technical solutions of the present invention, rather than limiting the same. Although the present invention has been described in detail with reference to the foregoing embodiments, those skilled in the art should understand that it is still possible to modify the technical solutions described in the foregoing embodiments or equivalently replace some or all of the technical features, and these modifications or replacements do not deviate the essence of the corresponding technical solutions from the scope of the technical solutions of each embodiment of the present invention.

1. A light emitting sensing device, comprising:
a non-translucent substrate, having a first surface with at least one recess formed on the first surface;
a light emitting element, being disposed in the at least one recess;
a light sensing element, being disposed on the first surface;
a first transparent material, being disposed in the at least one recess and covering the light emitting element; and
a second transparent material, being disposed on the first surface and covering the light sensing element.

2. The light emitting sensing device of claim 1, wherein a depth of the recess is 2 to 4 times of a height of the light emitting element.

3. The light emitting sensing device of claim 1, wherein the non-translucent substrate comprises a light absorbing material, light reflectance of the non-translucent substrate is 0%-10%, and light transmittance of the non-translucent substrate is 0%-5%.

4. The light emitting sensing device of claim 1, wherein the light emitting element comprises a light emitting diode for emitting infrared light.

5. The light emitting sensing device of claim 1, wherein the light sensing element senses visible light and invisible light.

6. The light emitting sensing device of claim 5, wherein the light sensing element comprises a first light sensing unit, a second light sensing unit and a processing unit, wherein the first light sensing unit is configured to sense visible light and output a corresponding sensing signal to the processing unit, and the second light sensing unit is configured to sense invisible light emitted by the light emitting element and output a corresponding sensing signal to the processing unit.

7. The light emitting sensing device of claim 6, wherein the first light sensing unit is an ambient light sensing unit, and the second light sensing unit is a distance sensing unit.

8. The light emitting sensing device of claim 7, wherein a wavelength of the visible light sensed by the ambient light sensing unit is 400 nm-700 nm, and a wavelength of the invisible light emitted by the light emitting element and sensed by the distance sensing unit is 800 nm-1100 nm.

9. The light emitting sensing device of claim 1, wherein the first transparent material and the second transparent material do not contact with each other.

10. The light emitting sensing device of claim 1, further comprising:
a color sensor and a third transparent material, wherein the color sensor is disposed on the first surface, and the third transparent material covers the color sensor.

11. The light emitting sensing device of claim 10, wherein the color sensor has a sensing region, and the sensing region comprises at least more than one of the following sensing regions:
red (R), green (G), blue (B), white (W), infrared (IR) and ultraviolet (UV) sensing regions; and
a light blocking structure is disposed between each sensing regions.

12. The light emitting sensing device of claim 11, wherein the color sensor comprises an R sensing region, a G sensing region, a B sensing region, a W sensing region, and an IR sensing region; the R sensing region, the G sensing region, the B sensing region, the W sensing region, and the IR sensing region form a sensing matrix in a parallel and bisymmetric manner, the R sensing region, the G sensing region, the B sensing region, and the W sensing region are symmetrically distributed with respect to the IR sensing region in the sensing matrix, or,
one of the R sensing region, the G sensing region, the B sensing region, the W sensing region and the IR sensing region is positioned as a center of a circle, and the remaining four sensing regions are symmetrically and radially distributed around the center.

13. The light emitting sensing device of claim 12, wherein the light blocking structure is made of metal or insulating material.

14. The light emitting sensing device of claim 11, wherein an R transparent sheet is disposed on the R sensing region, and a waveband sensed by the R sensing region is 590 nm-750 nm;
a G transparent sheet is disposed on the G sensing region, and a waveband sensed by the G sensing region is 495 nm-590 nm;
a B transparent sheet is disposed on the B sensing region, and a waveband sensed by the B sensing region is 380 nm-495 nm;
an IR transparent sheet is disposed on the IR sensing region, and a waveband sensed by the IR sensing region is 750 nm-1100 nm;
a W transparent sheet is disposed on the W sensing region, and the waveband sensed by the W sensing region is 380 nm-750 nm.

15. The light emitting sensing device of claim 1, further comprising:
a multichip light emitting element and a third transparent material, wherein the multichip light emitting element is disposed on the first surface, and the third transparent material covers the multichip light emitting element; and
the multichip light emitting device comprises at least more than one of the following light emitting chips:
red (R) light emitting chip, green (G) light emitting chip, blue (B) light emitting chip and white (W) light emitting chip.

16. The light emitting sensing device of claim 1, further comprising:
an ultraviolet sensing element and a third transparent material, wherein the ultraviolet sensing element is disposed on the first surface, and the third transparent material covers the ultraviolet sensing element.

17. The light emitting sensing device of claim 1, further comprising:
an infrared (IR) identifying light emitting element and a third transparent material, wherein the IR identifying light emitting element is disposed on the first surface, and the third transparent material covers the IR identifying light emitting element, and the light sensing element receives an infrared light emitted by the IR identifying light emitting element.

18. The light emitting sensing device of claim 1, further comprising:
a biomedical sensing module and a third transparent material, wherein the biomedical sensing module is disposed on the first surface, and the third transparent material covers the biomedical sensing module, and a wavelength of light emitted or received by the biomedical sensing module is 495 nm-570 nm.

19. The light emitting sensing device of claim 1, further comprising:
a breathing lamp and a third transparent material, wherein the breathing lamp is disposed on the first surface, and the third transparent material covers the breathing lamp; and
the breathing lamp comprises at least more than one of the following light emitting chips:
red (R) light emitting chip, green (G) light emitting chip, blue (B) light emitting chip and white (W) light emitting chip.

20. A light emitting sensing device, comprising:
a non-translucent substrate, having a first surface with at least one recess formed on the first surface;
a light emitting element, being disposed in the at least one recess;
a light sensing element, being disposed on the first surface;
a color sensor, being disposed on the first surface;
wherein the color sensor has a sensing region, the sensing region comprises: a red (R) sensing region, a green (G) sensing region, a blue (B) sensing region, a white (W) sensing region and an infrared (IR) sensing region.

21. The light emitting sensing device of claim 20, wherein the R sensing region, the G sensing region, the B sensing region, the W sensing region and the IR sensing region form a sensing matrix in a parallel and bisymmetric manner, and the R sensing region, and the G sensing region, the B sensing region and the W sensing region are symmetrically distributed with respect to the IR sensing region in the sensing matrix, or,
one of the R sensing region, the G sensing region, the B sensing region, the W sensing region and the IR sensing region is positioned as a center of a circle, and the remaining four sensing regions are symmetrically and radially distributed around the center.

22. The light emitting sensing device of claim 21, wherein an R transparent sheet is disposed on the R sensing region, and a waveband sensed by the R sensing region is 590 nm-750 nm;
a G transparent sheet is disposed on the G sensing region, and a waveband sensed by the G sensing region is 495 nm-590 nm;
a B transparent sheet is disposed on the B sensing region, and a waveband sensed by the B sensing region is 380 nm-495 nm;
an IR transparent sheet is disposed on the IR sensing region, and a waveband sensed by the IR sensing region is 750 nm-1100 nm;
a W transparent sheet is disposed on the W sensing region, and a waveband sensed by the W sensing region is 380 nm-750 nm.

23. The light emitting sensing device of claim 20, further comprising: a transparent material, wherein the transparent material is disposed in the recess and on the first surface, and covers the light emitting element, the light sensing element and the color sensor.

24. The light emitting sensing device of claim 20, wherein the color sensor further comprises a processing unit, the sensing region is located on the processing unit, and a plurality of pins for current and signal processing is disposed on the processing unit.

25. The light emitting sensing device of claim 24, wherein a ratio of a length to a width of the sensing region is 9:4;
a ratio of the length of the sensing region to a length of the processing unit is 1:2; and
a ratio of the width of the sensing region to a width of the processing unit is 1:7.

26. A method for manufacturing a light emitting sensing device, comprising:
partitioning a plurality of setting regions on a non-translucent substrate, each of the setting regions having a first surface;
forming a recess on the first surface in each of the setting regions by a first means;
disposing a light emitting element in the recess and disposing a light sensing element on the first surface in each of the setting regions;
covering the light emitting element with a first transparent material and covering the light sensing element with a second transparent material in each of the setting regions; and
cutting the non-translucent substrate by a second means to separate these setting regions.

27. The method for manufacturing a light emitting sensing device of claim 26, further comprising:
disposing a color sensor on the first surface;
covering the color sensor with a third transparent material.
